(19) United States
(12) Patent Application Publication
(10) Pub. No.: US 2006/0143366 A1
(43) Pub. Date: Jun. 29, 2006

(54) APPARATUS AND SYSTEM HAVING IN-SYSTEM-PROGRAMMING FUNCTION

(76) Inventors: Ying-Chih Yang, Hsinchu City (TW); Geng-Lin Chen, Hsinchu City (TW); Jen-Yi Liao, Hsinchu City (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/908,305

(22) Filed: May 6, 2005

(30) Foreign Application Priority Data
Dec. 24, 2004 (TW) 93140404

(51) Int. Cl. G06F 12/00

(52) U.S. Cl. 711/103

(57) ABSTRACT

An apparatus and a system having in-system-programming function are disclosed. The apparatus comprises a non-volatile memory, a controller and a serial interface unit. When the non-volatile memory is to be programmed, the controller will actively catch the program data from an external device via the serial interface unit and save the program data in non-volatile memory. Thus, the programming efficiency is enhanced, an additional programmer is unnecessary, and the production cost can be saved.

### CROSS-REFERENCE TO RELATED APPLICATION

This application claims the priority benefit of Taiwan application serial no. 93140404, filed on Dec. 24, 2004. All disclosure of the Taiwan application is incorporated herein by reference.

### BACKGROUND OF THE INVENTION

1. Field of Invention

The present invention relates to an apparatus having programming function, more particularly, to an apparatus having in-system-programming function.

2. Description of the Prior Art

Due to a continuous technology innovation, in the field of electronic circuit, its major role has been transited from the earliest vacuum tube to the semiconductor applications today by means of continuous efforts in innovation and developments by developers. Such drastic technology progress gives developers an endless challenge while leading into a significant change and impact on our daily life as well. Under the highly competitive environment, it has become one of the most concerned issues for R&D researchers to discover a new area which they can endeavor to further develop and invest.

In the high-technology society today, electronic consumer goods have become the most commonly used products in our daily life. With such goods, by means of simple command operations only, the life quality and the work efficiency can be significantly advanced. Among such products there are computers, PDAs (Personal Digital Assistant), mobile phones and so on. Such high-technology electronic consumer goods or other electronic apparatuses not only change the life style of people, but also bring a considerable profit to the manufacturers who engage themselves in the production and developments of these products.

More and more manufacturers have flung themselves into the developments. In recent years, the emergence of flash memory which is capable of storing data rapidly has been widely adapted to various electronic products. This also led a sharp drop of its prices in the market. However, the flash memory requires more number of pins in use, for instance, a data bus with 8-bits plus its address bus may have ten or more bits, even up to twenty or more bits, which requires twenty or thirty pins in total. For an IC (integrated circuit) with limited pins, the above-mentioned requirement is not suitable as such configuration of an IC will need a large size. To solve such problem, the SPI-flash memory has been applied in this field.

In the production of electronic devices having SPI-flash memories, it however may need to do an operation, so-called pre-programming, to write program codes into the SPI-flash memory in advance. To perform the operation of pre-programming, a programmer is needed for the writing operation. Nevertheless, such programmer is not popular yet among the manufacturers, which causes inconvenience in the production.

In summary, to use a SPI-flash memory, an operation to write pre-programmed codes in advance must be performed. Yet most of manufacturers in the field lack the programmer equipment which results in production inefficiency. In addition, an extra cost is required for purchasing such programmer for writing codes in advance.

### SUMMARY OF THE INVENTION

It is an object of the present invention to provide an apparatus having the in-system-programming function to reduce the production cost.

Another object of the present invention is to provide a system having the in-system-programming function which actively catches the pre-programmed data to be written from the external device, so that the production cost is reduced and the production speed is advanced.

The invention presents an apparatus having the in-system-programming function comprising a non-volatile memory, a serial interface unit and a controller. The non-volatile memory is used for saving program data. The serial interface unit is used for transmitting data in serial mode. The controller is coupled to the non-volatile memory and the serial interface unit. When the non-volatile memory is to be programmed, the controller actively catches the program data from an external device via the serial interface unit and saves the caught data into the non-volatile memory.

The present invention further provides a system having the in-system-programming function. The system includes an apparatus having the in-system-programming function and an external device. Wherein, the apparatus having the in-system-programming function comprises a non-volatile memory, a serial interface unit and a controller. The non-volatile memory is used for saving program data, the serial interface unit is used for transmitting the data in serial mode. The external device provides the program data and can be a computer, a parallel memory or an SPI-flash memory. When the non-volatile memory is to be programmed, the controller actively catches the program data from the external device via the serial interface unit and saves the caught data into the non-volatile memory.

The present invention uses an active in-system-programming mode that when there is no data saved in the memory of the system the system will actively catch the program data from the external device and save it in the memory so that the production cost is reduced and the production speed is advanced.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve for explaining the principles of the invention.

FIG. 1 is a configuration block diagram of the apparatus having in-system-programming function according to a preferred embodiment of the present invention.

FIG. 2 is a configuration block diagram of the system having in-system-programming function according to a preferred embodiment of the present invention.

FIG. 3 is a configuration block diagram of the system having in-system-programming function according to another preferred embodiment of the present invention.

### DESCRIPTION OF EMBODIMENTS

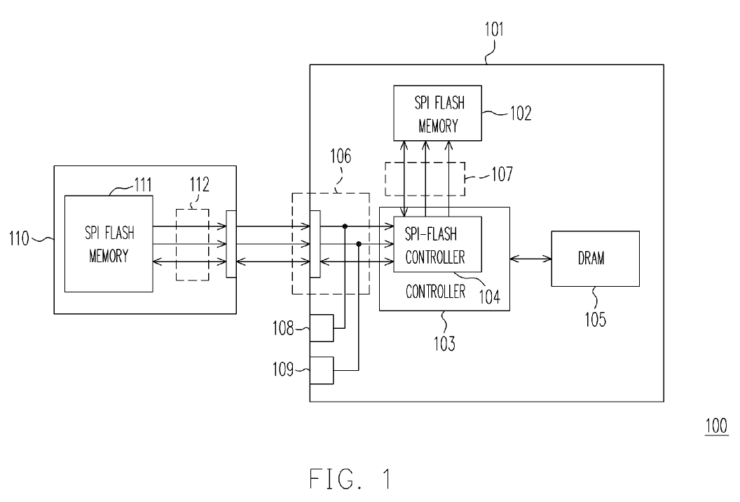

FIG. 1 is a configuration block diagram of the apparatus having in-system-programming function according to a preferred embodiment of the present invention. Referring to FIG. 1, the apparatus includes an apparatus having in-system-programming function 101 and an external device 110. Wherein, the apparatus having in-system-programming function 101 comprises an SPI-flash memory 102, a controller 103, an SPI-flash controller 104, a dynamic random access memory (DRAM) 105, a serial interface unit 106, a serial bus 107, an infrared detector 108 and a display screen 109.

The SPI-flash memory 102 is electrically coupled to the controller 103 via the serial bus 107, used for saving the program data written by the controller 103. The DRAM 105 is also used for saving program data.

The serial interface unit 106 is electrically coupled to the apparatus having in-system-programming function 101 and the external device 110, and transmits the program data saved in the external device 110 in serial mode.

The above-mentioned external device 110 includes an SPI-flash memory 111 and a serial bus 112. Wherein, the serial bus 112 is electrically coupled to the SPI-flash memory 111 and the serial interface unit 106, and transmits the program data saved in the serial flash memory 111 in serial mode.

The controller 103 includes the SPI-flash controller 104. Since the controller 103 supports the SPI-flash memory 102, while the SPI-flash controller 104 is writing the SPI-flash memory 102, the SPI-flash controller 104 reads the program data from specific three pins (which can be a shared pin of the other function under normal operation, for example, shared with the pin of the infrared detector 108 or of the display screen 109) according to the protocol with the SPI-flash memory. Thus, the program data can be read from the external device 110 and its programmed parameters can be also modified. Then, the firmware to be written is generated and written in the SPI-flash memory 102, and the in-system-programming function is achieved.

In this embodiment, when the apparatus having in-system-programming function 101 is to program the SPI-flash memory 102, the controller 103 will at first automatically detect the SPI-flash memory 102 and the DRAM 105 to see whether any program data is existing. If no program data in the SPI-flash memory 102 and the DRAM 105 is detected, the controller 103 take advantage of the inside SPI-flash controller 104, according to the protocol with the SPI flash memory, as described above, and actively catch the program data from the SPI-flash memory 111 in the external device 110 by using three specific pins via the serial interface unit 106 and the serial bus 112, and then to write the program data into the SPI-flash memory 102.

In this embodiment, when the apparatus having in-system-programming function 101 is power on, the controller 103 will automatically detect a predetermined pin. If the predetermined pin is in the status of default, the controller 103 will utilize the inside SPI-flash controller 104 according to the protocol with the SPI-flash memory, as above-described, and actively catch the program data from the SPI-flash memory 111 in the external device 110 by three specific pins via the serial interface unit 106 and the serial bus 112. Then, the firmware to be written will be generated and recorded into the SPI-flash memory 102 via the SPI-flash controller 104.

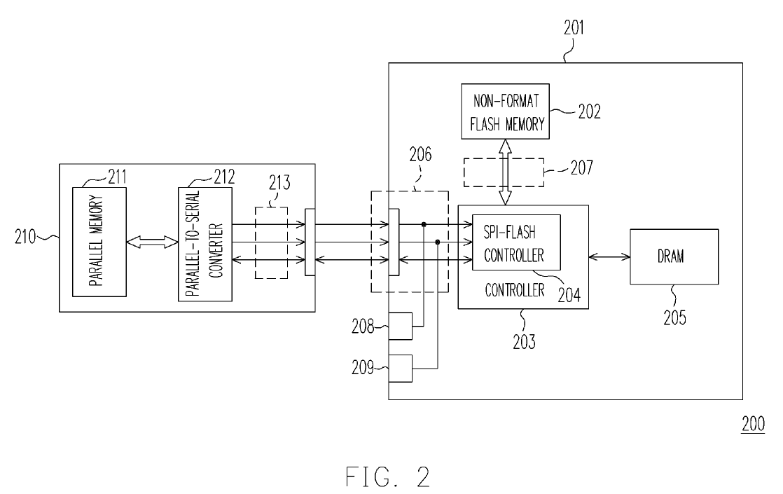

FIG. 2 is a configuration block diagram of the system with in-system-programming function according to the preferred embodiment of the present invention. Referring to FIG. 2, the system includes the apparatus with the in-system-programming function 201 and an external device 210. Wherein, the apparatus with the in-system-programming function 201 comprises a non-format flash memory 202, a controller 203, an SPI-flash controller 204, a dynamic random access memory (DRAM) 205, a serial interface unit 206, a non-format bus 207, an infrared detector 208 and a display screen 209.

The non-format flash memory 202 electrically couples to the controller 203 via the non-format bus 207 (may be a parallel bus) and is used for saving the program data written by the controller 203. The DRAM 205 is used for saving the program data as well.

The serial interface unit 206 is connected between the apparatus with the in-system-programming function 201 and the external device 210, and transmits the program data saved in the external device 210 in serial mode.

The above-mentioned external device 210 includes a parallel flash memory 211, a parallel-to-serial converter 212 and a serial bus 213. Wherein, the parallel-to-serial converter 212 electrically couples to the parallel flash memory 211, converts the parallel program data in the parallel memory 211 into serial data, and transmits the program data saved in the parallel memory 211 in serial mode via the serial bus 213 which is electrically coupled to the serial interface 206.

The controller 203 includes the SPI-flash controller 204. With the support of the controller 203 to the SPI-flash, the SPI-flash controller 204 takes advantage of the mode of power-on-self-testing-pins and reads the program data from specific three pins according to the protocol of the SPI-flash memory. Thus, the program data can be read from the external device 210, the programmed parameters can be also modified Then the firmware to be written is generated and written in the non-format flash memory 202, and the in-system-programming function is achieved.

In this embodiment, when the in-system-programming system is to program the non-format flash memory 202, the controller 203 will at first automatically detect the non-format flash memory 202 and the DRAM 205 to see whether any program data is existing. If no program data in the non-format flash memory 202 and the DRAM 205 is detected, the controller 203 will utilize the inside SPI-flash controller 204, as previously described, according to the protocol with the SPI flash memory, actively catch the program data from the parallel flash memory 211 in the external device 210 by means of specific three pins via the serial interface unit 206 and the serial bus 213. Then, the firmware to be written will be generated and recorded into non-format flash memory 202.

In this embodiment, when the apparatus with in-system-programming function 201 is power on, the controller 203 will automatically detect a predetermined pin. If the predetermined pin is in the status of default, the controller 203 will utilize the inside SPI-flash controller 204, according to the described protocol with the SPI flash memory, actively catch the program data from the parallel memory 211 in the external device 210 by means of specific three pins via the serial interface unit 206 and the serial bus 213. Then, the firmware to be written will be generated and recorded into non-format flash memory 202.

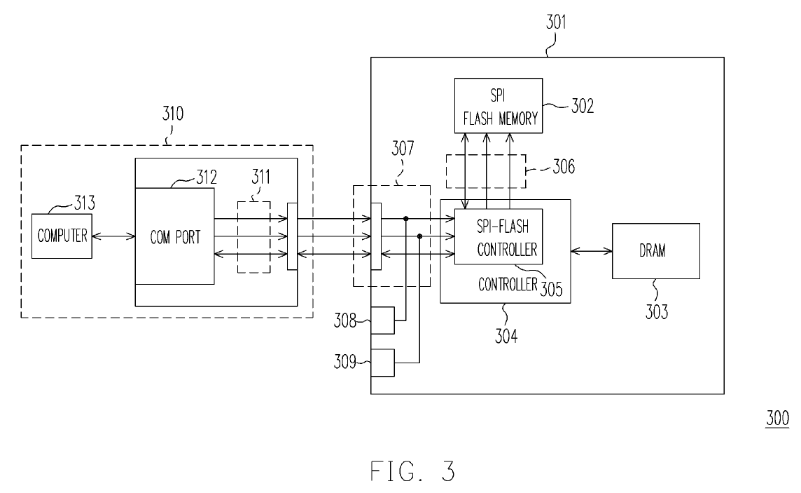

FIG. 3 is a configuration block diagram for the system with in-system-programming function according to another preferred embodiment of the present invention. Referring to FIG. 3, the system includes the apparatus with the in-system-programming function 301 and an external device 310. Wherein, the apparatus with the in-system-programming function 301 comprises a serial flash memory 302, a controller 304, an SPI-flash controller 305, a dynamic random access memory (DRAM) 303, a serial interface unit 307, a serial bus 306, an infrared detector 308 and a display screen 309. The apparatus with the in-system-programming function 301 has the same function as the above-described one in the previous embodiment, thus is omitted here.

The external device 310, other than the above-described second embodiment, includes a computer 313, a COM port 312 and a serial bus 311. The COM port 312 is electrically connected with the computer 313 to receive the program data saved in the computer 313. More particularly, the COM port is electrically connected with the serial interface unit 307 via the serial bus 311 and exports the program data saved in the computer 313 in serial mode via the serial bus 311.

In this embodiment, when the apparatus with in-system-programming function 301 is to program the SPI-flash memory 302, the controller 304 will at first automatically detect the SPI-flash memory 302 and the DRAM 303 to see whether any program data is existing. If no program data in the SPI-flash memory 302 and the DRAM 303 is detected, the controller 304 utilize the inside SPI-flash controller 305, according to the protocol with the SPI flash memory, and actively catch the programming data from the computer 313 in the external device 210 by using three specific pins via the serial interface unit 307 and the serial bus 311. Then, the firmware to be written will be generated and recorded into the SPI-flash memory 302 via the SPI-flash controller 305.

In this embodiment, when the apparatus having in-system-programming function 301 is power on, the controller 304 will automatically detect a predetermined pin. If the predetermined pin is in the status of default, the controller 304 will utilize the inside SPI-flash controller 305, according to the protocol with the SPI flash memory, as above-described, and actively catch the program data from the computer 313 in the external device 310 by three specific pins via the serial interface unit 307 and the serial bus 311. Then, the firmware to be written will be generated and recorded into the SPI-flash memory 302 via the SPI-flash controller 305.

In summary, when the apparatus with in-system-programming function of the present invention is to program the non-volatile memory, the controller will actively catch the program data from the external device via the serial interface unit and save it in the non-volatile memory, thus the programming efficiency is enhanced, the production cost. As a result, purchasing an additional programmer is not required.

It will be apparent to those skilled in the art that various modifications and variations can be made to the structure of the present invention without departing from the scope or spirit of the invention. In view of the foregoing, it is intended that the specification and examples to be considered as exemplary only, with a true scope and spirit of the invention being indicated by the following claims and their equivalents.

What is claimed is:

1. An apparatus having in-system-programming function comprising:
a non-volatile memory used for saving program data;
a serial interface unit used for transmitting the data; and
a controller coupled to said non-volatile memory and said serial interface unit which will actively catch said program data from an external device and save the data in said non-volatile memory when said non-volatile memory is to be programmed.

2. The apparatus having in-system-programming function as recited in claim 1, wherein said controller automatically detects said non-volatile memory for the existence of the program data, and when no data in said non-volatile memory is detected, said controller actively catches said program data from said external device via said serial interface unit, and saves the data in said non-volatile memory.

3. The apparatus having in-system-programming function as recited in claim 1, wherein, as said apparatus is power on, said controller detects a predetermined pin, and further, if said predetermined pin is in the status of default, said controller actively catches said program data from said external device via said serial interface unit, then saves the data in said non-volatile memory.

4. The apparatus having in-system-programming function as recited in claim 1, wherein said controller is also connected with said non-volatile memory via a serial bus.

5. The apparatus having in-system-programming function as recited in claim 1, wherein said controller is connected with said non-volatile memory via a parallel bus.

6. The apparatus having in-system-programming function as recited in claim 1, wherein said external device includes:
an outside parallel memory used for saving said program data; and
a parallel-to-serial converter connected with said outside parallel memory to convert said program data saved in said outside parallel memory to serial data so that said controller can actively catch said program data from said external device via said serial interface unit.

7. The apparatus having in-system-programming function as recited in claim 1, wherein said external device includes a computer containing a COM port, and, when said controller actively catches said program data from said external device, said computer exports said program data via said COM port.

8. The apparatus having in-system-programming function as recited in claim 1, wherein said external device is a SPI flash memory.

9. The apparatus having in-system-programming function as recited in claim 1, wherein said controller also includes:
a SPI-flash controller which utilizes said serial interface unit to read in said data.

10. The apparatus having in-system-programming function as recited in claim 1, wherein said non-volatile memory is a SPI flash memory.

11. A system having in-system-programming function including:
an apparatus having in-system-programming function comprising a non-volatile memory used for saving program data, a serial interface unit used for transmitting the data in serial mode and a controller coupled to said non-volatile memory and said serial interface unit; and
an external device coupled to said apparatus having in-system-programming function to provide said program data;
wherein, when said non-volatile memory is to be programmed, said controller actively catches said program data from the external device via said serial interface unit and saves the data in said non-volatile memory.

12. The system having in-system-programming function as recited in claim 11, wherein said controller automatically detects said non-volatile memory for the existence of the program data, and when no data in said non-volatile memory is detected, said controller actively catches said program data from said external device via said serial interface unit, and saves the data in said non-volatile memory.

13. The system having in-system-programming function as recited in claim 11, wherein as said apparatus is power on, said controller detects a predetermined pin, and further, if said predetermined pin is in the status of default, said controller actively catches said program data from said external device via said serial interface unit, and saves the data in said non-volatile memory.

14. The system having in-system-programming function as recited in claim 11, wherein said controller is also connected with said non-volatile memory via a serial bus.

15. The system having in-system-programming function as recited in claim 11, wherein said controller is connected with said non-volatile memory via a parallel bus.

16. The system having in-system-programming function as recited in claim 11, wherein said external device includes:
an outside parallel memory used for saving said program data; and
a parallel-to-serial converter connected with said outside parallel memory to convert said program data saved in said outside parallel memory to serial data so that said controller can actively catch said program data from said external device via said serial interface unit.

17. The system having in-system-programming function as recited in claim 11, wherein said external device includes a computer containing a COM port, and, when said controller actively catches said program data from said external device, said computer exports said program data via said COM port.

18. The system having in-system-programming function as recited in claim 11, wherein said external device is a SPI flash memory.

19. The system having in-system-programming function as recited in claim 11, wherein said controller also includes:
a SPI-flash controller which utilizes said serial interface unit to read in said data.

20. The system having in-system-programming function as recited in claim 11, wherein said non-volatile memory is a SPI flash memory.
